(19) United States
(12) Patent Application Publication
(10) Pub. No.: US 2015/0012139 A1
(43) Pub. Date: Jan. 8, 2015

(54) UPDATING METHOD FOR FAN CONTROL TABLE FILE

(71) Applicants: Inventec Corporation, Taipei (TW); Inventec (Pudong) Technology Corporation, Shanghai (CN)

(72) Inventor: Peng HU, Shanghai (CN)

(73) Assignees: Inventec Corporation, Taipei (TW); Inventec (Pudong) Technology Corporation, Shanghai (CN)

(21) Appl. No.: 14/048,964

(22) Filed: Oct. 8, 2013

(30) Foreign Application Priority Data
Jul. 4, 2013 (CN) 201310279252.8

(51) Int. Cl. G05B 15/02

(52) U.S. Cl. CPC G05B 15/02
USPC 700/275

(57) ABSTRACT

An updating method for a fan control table file includes the following steps: generating a fan speed controlling file in a client device; outputting a fan control table updating command from the client device to a baseboard management controller (BMC) of a sever, which stores a first fan control table file comprising a fan speed control rule for the server; the BMC entering a fan control table updating mode after receiving the fan control table updating command; establishing a temporary file in the BMC; the BMC storing content of the fan speed controlling file, which is received from the client device, in the temporary file to form a second fan control table file, and updating the first fan control table file according to the second fan control table file; the BMC exiting the fan control table updating mode; and deleting the second fan control table file.

### CROSS-REFERENCE TO RELATED APPLICATIONS

This non-provisional application claims priority under 35 U.S.C. §119(a) on Patent Application No(s). 201310279252.8 filed in China on Jul. 4, 2013, the entire content of which are hereby incorporated by reference.

### BACKGROUND OF THE INVENTION

1. Technical Field of the Invention

The disclosure relates to a data updating method, more particularly to an updating method for fan control table file.

2. Description of the Related Art

Heat dissipation to a server in the art is a very concern for many manufacturers. The design of heat dissipation may vary with many factors such as the various dispositions of servers and the environments of various machine rooms. Recently, the design of heat disposition usually focuses on the design of cooling fan, especially on the speed design of fan control table (FCT). For most of the servers, the FCT is stored in the firmware of a baseboard management controller (BMC) in the server. To achieve a better performance of server and a better ability of heat disposition, the FCT is required to be arranged or amended in the duration of operating the server.

In general, there are two ways to update or arrange the FCT. The first one is that an alpha version of the FCT is utilized to perform a test task and is not actually replaced or installed. The alpha version of the FCT is further amended according to the test result until the desire test goal is reached, and then the finial amended alpha version of the FCT will be installed and performed. This needs to unceasingly perform test tasks, resulting in a great deal of consumptions on time and labors. The second one is that the BMC supports the on-line amending to the on-line FCT. Specifically, it has to output a command to the BMC according to the format of the FCT, so as to update the FCT in real time. This causes an unfriendly operation interface and the difficult of maintaining such a FCT with a complicated format. Moreover, when the FCT is being updated, the BMC will consume more storage resources.

### SUMMARY OF THE INVENTION

According to an embodiment of the disclosure, an updating method for a fan control table file includes the following steps: generating a fan speed controlling file in a client device; outputting a fan control table updating command from the client device to a baseboard management controller of a sever, which stores a first fan control table file comprising a fan speed control rule for the server; the baseboard management controller entering a fan control table updating mode after receiving the fan control table updating command; establishing a temporary file in the baseboard management controller; the baseboard management controller receiving content of the fan speed controlling file from the client device and storing the content of the fan speed controlling file in the temporary file to form a second fan control table file; the baseboard management controller updating the first fan control table file according to the second fan control table file; the baseboard management controller exiting the fan control table updating mode; and deleting the second fan control table file.

In an embodiment, the step of generating a fan speed controlling file in the client device includes the following steps: providing a user interface via the client device; displaying fan speed arrangement information on the user interface; modifying the fan speed arrangement information on the user interface by a user and saving the modified fan speed arrangement information as a fan speed arrangement file; and executing a first transformation of the fan speed arrangement file via the client device to form the fan speed controlling file.

In an embodiment, the first transformation of the fan speed arrangement file is to transform the content of the fan speed arrangement file to binary code or hex code to form the fan speed controlling file.

In an embodiment, the fan speed arrangement file and the fan speed controlling file have a same fan speed control rule, but the format of the content of the fan speed controlling file, which is binary or hexadecimal, is different from the format of the content of the fan speed arrangement file.

In an embodiment, the step of displaying the fan speed arrangement information on the user interface includes the following steps: outputting a reading command from the client device to the baseboard management controller; transmitting the first fan control table file from the baseboard management controller to the client device; the client device reading the first fan control table file and executing a second transformation of the first fan control table file; and the client device displaying a result of the second transformation of the first fan control table file on the user interface as the fan speed arrangement information. In an embodiment, the second transformation of the first fan control table file is to transform a format of the content of the first fan control table file to form the fan speed arrangement information. Moreover, the format of the content of the first fan control table file, which is binary or hexadecimal, is different from the format of the fan speed arrangement information in an embodiment.

Alternately, another embodiment of displaying the fan speed arrangement information on the user interface includes the following steps: the client device reading a third fan control table file stored in the client device; the client device executing a second transformation of the third fan control table file; and the client device displaying a result of the second transformation of the third fan control table file on the user interface as the fan speed arrangement information. In this embodiment, content of the third fan control table file is same as or different from the content of the first fan control table file, and even the second transformation of the third fan control table file is to transform a format of the content of the third fan control table file to form the fan speed arrangement information. Moreover, the format of the content of the third fan control table file, which is binary or hexadecimal, is different from the format of the fan speed arrangement information in an embodiment.

In an embodiment, the fan speed arrangement information displayed on the user interface comprises a quantity of sensors, data of a temperature upward curve for the sensors, data of a temperature downward curve for the sensors, data of a speed upward curve, and data of a speed downward curve. Furthermore, the fan speed arrangement information displayed on the user interface in an embodiment includes a serial number of version, a publication date, manufacturer information, and a project code.

In an embodiment, the first transformation of the fan speed arrangement file is executed by an updating unit of the client device, and the fan control table updating command is outputted from the updating unit to the baseboard management controller.

In an embodiment, after deleting the second fan control table file, the updating method further includes the following steps: restarting the baseboard management controller; and executing the updated first fan control table file to control fans of the sever.

In an embodiment, the content of the fan speed controlling file is received from the client device by the baseboard management controller repeatedly until the content of the fan speed controlling file is received entirely.

In an embodiment, the step of updating the first fan control table file according to the second fan control table file via the baseboard management controller includes the following steps: via the baseboard management controller, replacing content of the first fan control table file by a copy of content of the second fan control table file.

In an embodiment, content of the first fan control table file and content of the second fan control table file satisfy a binary format or a hexadecimal format. Alternately, the content of the fan speed controlling file satisfies a binary format or a hexadecimal format.

In an embodiment, before the baseboard management controller receives the content of the fan speed controlling file, the temporary file is empty.

### BRIEF DESCRIPTION OF THE DRAWINGS

The present disclosure will become more fully understood from the detailed description given herein below for illustration only and thus does not limit the present disclosure, wherein:

FIG. 1 is a block diagram of an updating system performing an updating method for a fan control table file according to an embodiment of the disclosure;

FIG. 2 is a flowchart of the updating method for a fan control table file according to an embodiment of the disclosure;

FIG. 3 is a flowchart of generating the fan speed controlling file according to an embodiment;

FIG. 4 is a flowchart of an embodiment of displaying fan speed arrangement information on the user interface; and

FIG. 5 is a flowchart of another embodiment of displaying fan speed arrangement information on the user interface.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

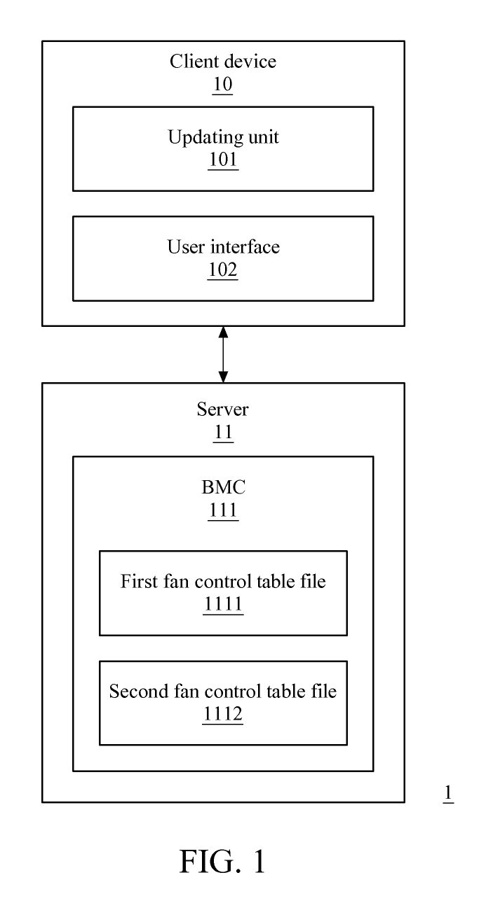

FIG. 1 is a block diagram of an updating system performing an updating method for a fan control table file according to an embodiment of the disclosure. An updating system 1 includes a client device 10 and a server 11. The client device 10 and the server 11 communicate with each other through a communication manner such as a local area network (LAN) or a wireless network. For example, the client device 10 is a desktop computer or a notebook. The client device 10 includes an updating unit 101 and a user interface 102. For example, the updating unit 101 is a storage device storing an updating program. In this example, the updating unit 101 executes the updating program to generate a fan speed controlling file and send a fan control table updating command to the server 11. The updating program is, for example, a window application program of the Microsoft Windows 32-bit.

A fan speed arrangement file includes content about fan speed controlling, for example, a serial number of version, a publication date, a manufacturer name, a project code, a quantity of fans, a quantity of speed levels, a quantity of sensors, a quantity of sensors for fans, information of a temperature output interface, data of a temperature upward curve, data of a temperature downward curve, data of a speed upward curve and data of a speed downward curve. The fan control table updating command sent by the updating unit 101 is used for requesting the server 11 to updating data in the first fan control table file 1111.

The server 11 includes a baseboard management controller (BMC) 111 including a first fan control table file 1111. The BMC 111 is a chip set disposed on a mainboard of the server 11 in this or some embodiments and is be configured to monitor the working status of the server 11. The first fan control table file 1111 can be currently stored in a firmware of the BMC 111 in this or some embodiments. A temporary file is established after the server 11 receives the fan control table updating command, and is used for temporarily storing the content of the fan speed controlling file of the client device 10 to form a second fan control table file 1112.

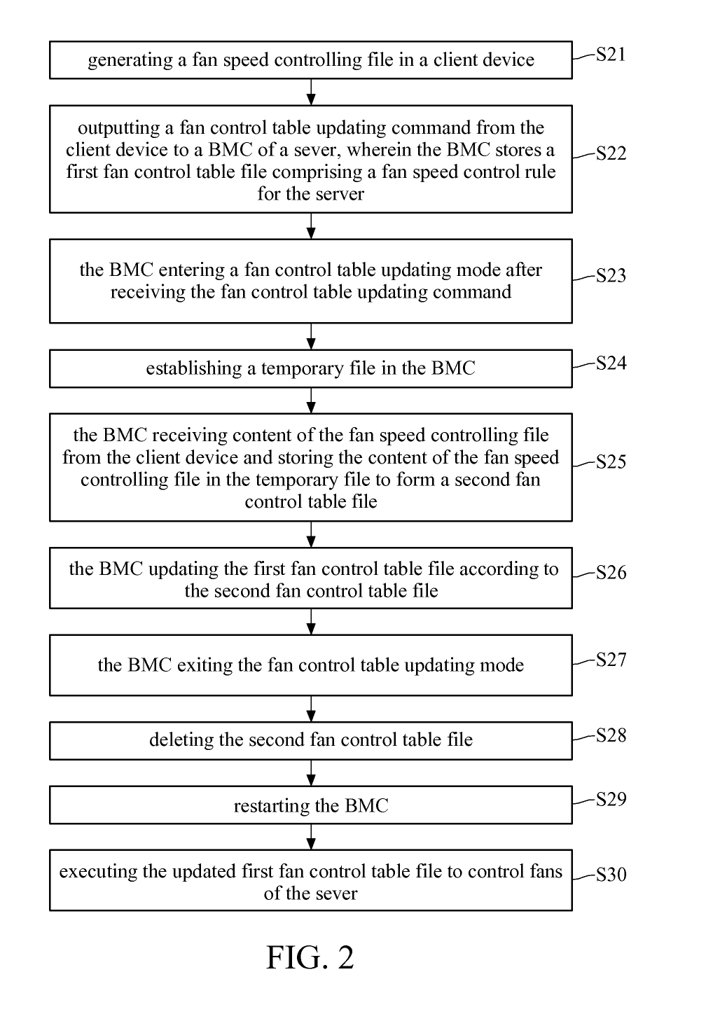

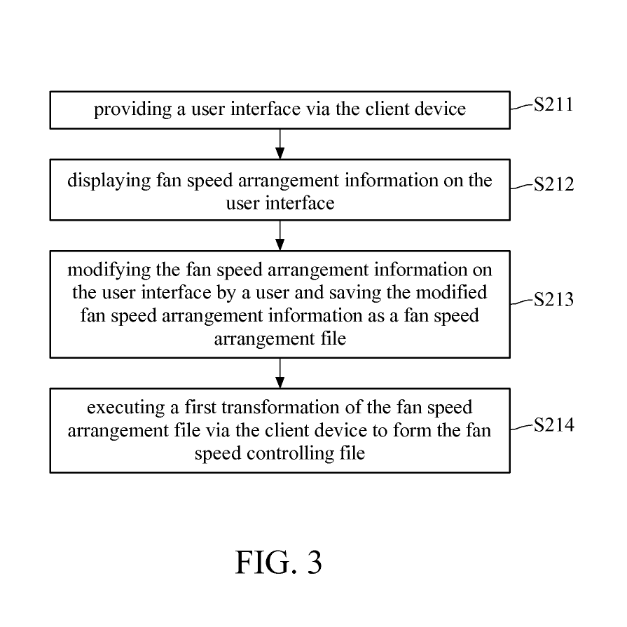

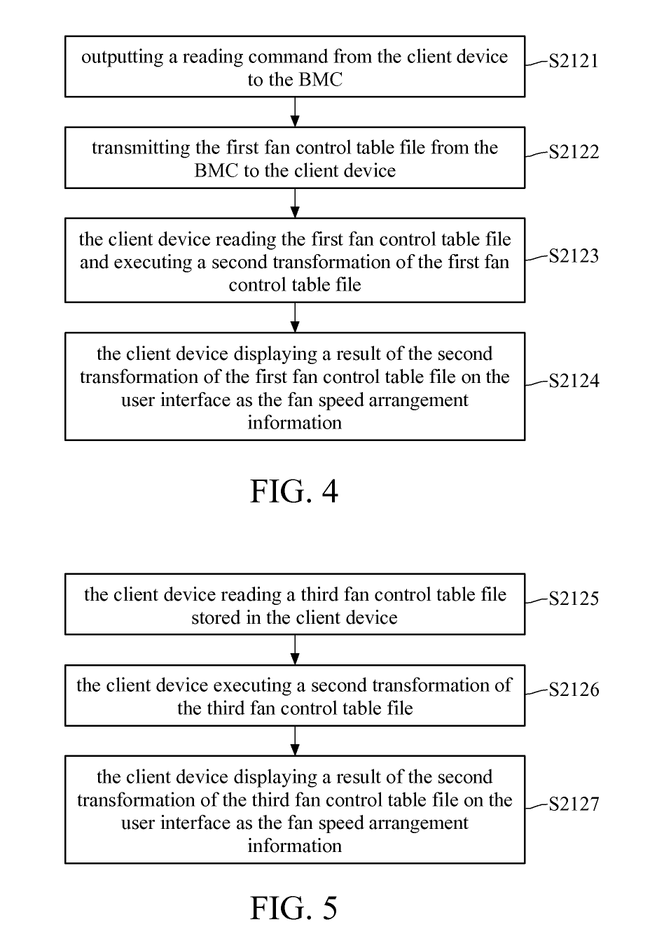

The detailed operation of the updating system 1 in FIG. 1 is described below. Refer to FIG. 2 to FIG. 5, an updating method for a fan control table file is described as follows according to an embodiment of the disclosure. Firstly, the client device 10 generates a fan speed controlling file (step S21). For instance, the client device 10 uses application software within to set the fan speed controlling file.

Generating the fan speed controlling file in the client device 10 comprises: providing a user interface 102 via the client device 10 (step S211); displaying fan speed arrangement information on the user interface 102 (step S212); modifying the fan speed arrangement information on the user interface 102 by a user and saving the modified fan speed arrangement information as a fan speed arrangement file (step S213); and executing a first transformation of the fan speed arrangement file via the client device 10 to form the fan speed controlling file (step S214). For example, the fan speed arrangement information recording a fan speed control rule is shown in Table 1. User manually fills in or modifies the fan speed arrangement information to make the filled or modified fan speed arrangement information comprise a fan speed control rule the user wants and different from the fan speed control rule of first fan control table file 1111. The format of the content of the fan speed controlling file is different from the format of the content of the fan speed arrangement file. The first transformation of the fan speed arrangement file is to transform the content of the fan speed arrangement file to binary code or hex code to form the fan speed controlling file; This means that the fan speed arrangement file and the fan speed controlling file comprise the same fan speed control rule but the format of the content of the fan speed controlling file is binary code or hex code and of different from the format of the content of the fan speed arrangement file. Displaying fan speed arrangement information on the user interface 102 comprises: outputting a reading command from the client device 10 to the BMC 111 (step S2121); transmitting the first fan control table file 1111 from the BMC 111 to the client device 10 (step S2122); the client device 10 reading the first fan control table file 1111 and executing a second transformation of the first fan control table file 1111 (step S2123); and the client device 10 displaying a result of the second transformation of the first fan control table file 1111 on the user interface 102 as the fan speed arrangement information (step S2124). The second transformation of the first fan control table file 1111 is to transform a format of the content of the first fan control table file 1111 to form the fan speed arrangement information. The second transformation is a reverse process of the first transformation. Another way of displaying fan speed arrangement information on the user interface 102 comprises: the client device 10 reading a third fan control table file stored in the client device 10 (step S2125); the client device 10 executing a second transformation of the third fan control table file (step S2126); and the client device 10 displaying a result of the second transformation of the third fan control table file on the user interface 102 as the fan speed arrangement information (step S2127). The content of the third fan control table file is same as or different from the content of the first fan control table file 1111. The second transformation of the third fan control table file is to transform the format of the content of the third fan control table file to form the fan speed arrangement information. The content of the third fan speed control table satisfies a binary format or a hexadecimal format. The first transformation of the fan speed arrangement file, the second transformation of the first fan control table file 1111, and the second transformation of the third fan control table file are all executed by the updating unit 101 of the client device 10.

TABLE 1

| Items | Note | Code |
|---|---|---|
| Serial number of version | The information specifying the | Version |
| | version of the fan speed control table | |
| Publication date | The publication date of fan control | Release_Date |
| | table file | |
| Manufacturer information | The Manufacturer information of fan | Factory |
| | control table file | |
| Project code | The project code of fan control table | Project |
| | file | |
| Quantity of sensors for fan | The quantity of sensors sensing fan | EntrySum |
| | speeds | |
| Quantity of speed levels | The quantity of speed levels that the | FieldSum |
| | fan speed can adjusted | |
| Quantity of sensors for CPU | The quantity of sensors sensing the | SensorNum |
| | temperatures of the CPU | |
| Information of temperature output | Information to specify the electronic | PwmPin |
| interface | interface used for controlling the fan | |
| | speed | |
| Data of temperature upward curve | Thresholds of temperature ranges to | Pwm_upt |
| | specify what the temperature of CPU | |
| | is increased to | |
| Data of speed upward curve | Thresholds of speed ranges to specify | Pwm_upd |
| | what the fan speed is increased to | |
| Data of temperature downward curve | Thresholds of temperature ranges to | Pwm_downt |
| | specify what the temperature of CPU | |
| | is reduced to | |
| Data of speed downward curve | Thresholds of speed ranges to specify | Pwm_downd |
| | what the fan speed is reduced to | |

In Table 1, it shows the fan speed arrangement information displayed on the user interface 102. In Table 1, the serial number of version, the publication date, the manufacturer information, the project code, the quantity of sensors for fans, the quantity of speed levels, the quantity of sensors for CPU, and the information of temperature output interface are, for example, presented by words. The quantity of speed levels corresponds to a quantity of temperature ranges of the temperature upward curve, a quantity of speed ranges of the speed upward curve, a quantity of temperature ranges of the temperature downward curve and a quantity of speed ranges of the speed downward curve. Assume that the quantity of speed levels is 5, then there will be five temperature ranges in the temperature upward curve and there will be five speed ranges in the speed upward curve. The information of temperature output interface can be presented with words, digits (codes) or any combination thereof. For example, a pin whose serial number is 0x03 will be presented with a character string 0x03 in the fan speed arrangement file. The Data of the temperature upward curve, the data of the speed upward curve, the data of the temperature downward curve and the data of the speed downward curve are, for example, presented with one-dimensional arrays. Specifically, the data of the temperature upward curve corresponds to the data of the speed upward curve and is presented with the one-dimensional array such as Pwm_upt [50:60:70:80] including various temperature thresholds, e.g. 50, 60, 70 and 80, and the data of the speed upward curve presented with the one-dimensional array, e.g. Pwm_upd[200:300:400:500], includes various speed values as thresholds, e.g. 200, 300, 400 and 500. These temperature thresholds of the temperature upward curve correspond to the speed values of the speed upward curve respectively. In other words, the quantity of the temperature thresholds is the same as the quantity of the speed values. Moreover, the control of fan speed is based on the sensing result of temperature. When the sensed temperature is up to one temperature threshold recorded in the temperature upward curve, the fan speed will be increased to be one speed value corresponding to the temperature threshold, and vice versa. The fan speed controlling file at least includes a serial number of version, a quantity of the at least one sensor, the data of the temperature upward curve for the at least one sensor and the data of the temperature downward curve for the at least one sensor. The at least one sensor is configured to sense the temperature of the server 11.

After the fan speed controlling file is generated by the client device 10, the client device 10 outputs a fan control table updating command to the BMC 111 of the server 11 (step S22). For instance, the client device 10 sends the fan control table updating command to the BMC 111 in the server 11 when executing the updating program via the updating unit 101. After the BMC 111 in the server 11 receives the fan control table updating command, the server 11 enters a fan control table updating mode (step S23). Then, the server 11 establishes a temporary file in the BMC 111 (step S24). The temporary file is empty at this time. The temporary file and the first fan control table file 1111 are stored in a firmware of the BMC 111.

After the temporary file is established, the server 11 receives the content of the fan speed controlling file sent by the client device 10, and stores the content of the fan speed controlling file in the temporary file to form a second fan control table file 1112 (step S25). The second fan control table file 1112 allows the content of the fan speed controlling file to be temporarily stored within. The BMC 111 updates the first fan control table file 1111 according to the second fan control table file 1112 (step S26). After the first fan control table file 1111 is updated, the BMC 111 exits the fan control table updating mode (step S27). Then the second fan control table file 1112 is deleted via the BMC 111 (step S28), so that the storage space of the firmware of the BMC 111 is saved. Further the BMC 111 is restarted (step S29), so that the updated first fan control table file 1111 go into effect. The BMC 111 or the server 11 executes the updated first fan control table file 1111 to control fans of the sever 11 (step S30).

In an embodiment, before the server 11 receives the content of the fan speed controlling file sent by the client device 10 and stores the content of the fan speed controlling file in the temporary file to form a second fan control table file 1112, the server 11 can respond to the fan control table updating command sent by the client device 10 and waits to receive the content of the fan speed controlling file outputted by the client device 10 and the client device 10 receives the response from the server 11 and then sends the content of the fan speed controlling file to the server 11. After the server 11 finishes the updating task, the BMC 111 further outputs a notification message to the client device 10, so that the notification can be presented by the client device 10 to notify a user that the updating task is successful.

The client device 10 transforms the fan speed arrangement file via the updating unit 101, and outputs the updating request to the BMC 111 via the updating unit 101.

In an embodiment, the BMC 111 receives the content of the speed controlling file outputted by the client device 10 one part by one part until the content of the speed control file is received completely. Before the BMC 111 begins to receive the content of the speed controlling file, the temporary file is empty.

After the content of the first fan control table file 1111 is updated, the second fan control table file 1112 is deleted, and the BMC 111 is restarted. After the server 11 finishes the updating task, the BMC 111 sends a notification message to the client device 10. The notification message will be presented by the client device 10 to notify a user that the updating task is successful.

Additionally, to update the first fan control table file 1111 according to the second fan control table file, the BMC 111 can replace the content of the first fan control table file 1111 by a copy of the content of the second fan control table file 1112. In this or some embodiment, the content of the first fan control table file 1111 and the content of the second fan control table file 1112 satisfy a binary format or a hexadecimal format, and the content of the fan speed controlling file satisfies a binary format or a hexadecimal format. The content of the first fan control table file 1111 and the content of the fan speed controlling file have the same format.

As set forth above, whenever the setting of the heat dissipation to the server needs to be updated, it is a good choice to use the updating method for fan control table files in the disclosure. Further it provides the user a simple and friendly updating interface to update or modify the fan speed control setting to what he wants. This may make the user's work more convenient.

What is claimed is:

1. An updating method for a fan control table file, comprising:
generating a fan speed controlling file in a client device;
outputting a fan control table updating command from the client device to a baseboard management controller of a server, wherein the baseboard management controller stores a first fan control table file comprising a fan speed control rule for the server;
the baseboard management controller entering a fan control table updating mode after receiving the fan control table updating command;
establishing a temporary file in the baseboard management controller;
the baseboard management controller receiving content of the fan speed controlling file from the client device and storing the content of the fan speed controlling file in the temporary file to form a second fan control table file;
the baseboard management controller updating the first fan control table file according to the second fan control table file;
the baseboard management controller exiting the fan control table updating mode; and
deleting the second fan control table file.

2. The updating method according to claim 1, wherein generating a fan speed controlling file in the client device comprises:
providing a user interface via the client device;
displaying fan speed arrangement information on the user interface;
modifying the fan speed arrangement information on the user interface by a user and saving the modified fan speed arrangement information as a fan speed arrangement file; and
executing a first transformation of the fan speed arrangement file via the client device to form the fan speed controlling file.

3. The updating method according to claim 2, wherein the first transformation of the fan speed arrangement file is to transform content of the fan speed arrangement file to binary code or hex code to form the fan speed controlling file.

4. The updating method according to claim 2, wherein the fan speed arrangement file and the fan speed controlling file have a same fan speed control rule, and a format of the content of the fan speed controlling file, which is binary or hexadecimal, is different from a format of content of the fan speed arrangement file.

5. The updating method according to claim 2, wherein displaying the fan speed arrangement information on the user interface comprises:
outputting a reading command from the client device to the baseboard management controller;
transmitting the first fan control table file from the baseboard management controller to the client device;
the client device reading the first fan control table file and executing a second transformation of the first fan control table file; and
the client device displaying a result of the second transformation of the first fan control table file on the user interface as the fan speed arrangement information.

6. The updating method according to claim 5, wherein the second transformation of the first fan control table file is to transform a format of content of the first fan control table file to form the fan speed arrangement information.

7. The updating method according to claim 5, wherein a format of content of the first fan control table file, which is binary or hexadecimal, is different from a format of the fan speed arrangement information.

8. The updating method according to claim 2, wherein displaying the fan speed arrangement information on the user interface comprises:
the client device reading a third fan control table file stored in the client device;
the client device executing a second transformation of the third fan control table file; and
the client device displaying a result of the second transformation of the third fan control table file on the user interface as the fan speed arrangement information.

9. The updating method according to claim 8, wherein content of the third fan control table file is same as or different from content of the first fan control table file.

10. The updating method according to claim 8, wherein the second transformation of the third fan control table file is to transform a format of the content of the third fan control table file to form the fan speed arrangement information.

11. The updating method according to claim 8, wherein the format of the content of the third fan control table file, which is binary or hexadecimal, is different from the format of the fan speed arrangement information.

12. The updating method according to claim 2, wherein the fan speed arrangement information displayed on the user interface comprises a quantity of sensors, data of a temperature upward curve for the sensors, data of a temperature downward curve for the sensors, data of a speed upward curve, and data of a speed downward curve.

13. The updating method according to claim 12, wherein the fan speed arrangement information displayed on the user interface further comprises a serial number of version, a publication date, manufacturer information, and a project code.

14. The updating method according to claim 2, wherein the first transformation of the fan speed arrangement file is executed by an updating unit of the client device, and the fan control table updating command is outputted from the updating unit to the baseboard management controller.

15. The updating method according to claim 1, wherein after deleting the second fan control table file, further comprises:
restarting the baseboard management controller; and
executing the updated first fan control table file to control fans of the sever.

16. The updating method according to claim 1, wherein the content of the fan speed controlling file is received from the client device by the baseboard management controller repeatedly until the content of the fan speed controlling file is received entirely.

17. The updating method according to claim 1, wherein updating the first fan control table file according to the second fan control table file via the baseboard management controller comprises:
via the baseboard management controller, replacing content of the first fan control table file by a copy of content of the second fan control table file.

18. The updating method according to claim 1, wherein content of the first fan control table file and content of the second fan control table file satisfy a binary format or a hexadecimal format.

19. The updating method according to claim 1, wherein the content of the fan speed controlling file satisfies a binary format or a hexadecimal format.

20. The updating method according to claim 1, wherein before the baseboard management controller receives the content of the fan speed controlling file, the temporary file is empty.
